(19) United States
(12) Patent Application Publication
(10) Pub. No.: US 2014/0249834 A1
(43) Pub. Date: Sep. 4, 2014

(54) METHODS, APPARATUSES AND COMPUTER PROGRAM PRODUCTS FOR PROVIDING TECHNIQUES FOR USERS TO CREATE HEALTH CARE SOLUTIONS

(71) Applicant: CARADIGM USA LLC, Bellevue, WA (US)

(72) Inventors: Jonathan D'Souza, Kirkland, WA (US); Lynn Taylor, Murray, UT (US); Ben Chronister, Woodinville, WA (US); Peter Burns, Seattle, WA (US); Abbas Kurawarwala, Issaquah, WA (US); Jay Iyer, Seattle, WA (US); Neal Singh, Redmond, WA (US); Oliver Chen, Beijing (CN)

(73) Assignee: CARADIGM USA LLC, Bellevue, WA (US)

(21) Appl. No.: 13/783,320

(22) Filed: Mar. 3, 2013

(51) Int. Cl. G06Q 10/10; G06Q 50/22

(52) U.S. Cl. CPC G06Q 10/10; G06Q 50/22
USPC 705/2

(57) ABSTRACT

An apparatus is provided for identifying patients of a cohort. The apparatus may include at least one memory and at least one processor configured to generate at least one user interface defining items of predefined criteria to identify a plurality of patients, among a candidate set of patients, of a cohort. The patients have at least one common characteristic associated with a designated medical condition or a designated health plan. The processor is also configured to identify the plurality of patients of the cohort in response to receiving indications of selections of one or more of the items of the predefined criteria. The processor is also configured to monitor and manage care of the identified patients of the cohort on an ongoing basis to provide interventions and track outcomes. Corresponding computer program products and methods are also provided.

### TECHNOLOGICAL FIELD

Embodiments of the invention relate generally to a mechanism of facilitating user interaction with health care data and more particularly relate to a method, apparatus and computer program product for defining criteria for identification of a patient cohort of interest and configuring one or more user interfaces with patient information for the patients in the cohort.

### BACKGROUND

Currently, the problems in enterprise health care information technology are typically too vast for any one vendor or solution set to address. This may result in a lot of custom software development needed in health care organizations which may be an expensive proposition. Furthermore, clinicians (e.g., nurses, physicians, knowledge workers, laboratory technicians, etc.), that are most attuned to the problems and needed health care solutions may not have access to an adequate toolset for their technical capabilities that allows them to easily address some of their needs themselves such as, for example, defining criteria for selection of a cohort of patients and managing the cohort of patients.

As such, clinicians may be reliant on an information technology team to help develop health care solutions. However, at present information technology teams may not be staffed enough to keep up with the demands for solutions across their health care organizations. A larger number of these needs may involve management of a cohort of patients in which a clinician may need or desire to develop health care solutions to manage and monitor the patient cohort of interest.

In view of the foregoing drawbacks, it may be beneficial to provide a mechanism to enable clinicians to easily and efficiently address or develop some of their health care solution needs themselves.

### BRIEF SUMMARY

A method, apparatus and computer program product are therefore provided that may provide an efficient and reliable mechanism for managing a cohort of patients. In this regard, the exemplary embodiments may enable defining of criteria for identification of a patient cohort of interest and enabling provision of one or more configurable user interfaces which provide patient information for the patients in the cohort.

In this regard, the exemplary embodiments may enable a user to define a new health care cohort management solution using a guided experience. As such, the exemplary embodiments may enable (1) defining of criteria for identification of a cohort of patients, (2) visually laying out and configuring views of patient information for patients in the cohort, (3) visually configuring reports, dashboards and other analytics as well as (4) specifying various workflows that may orchestrate surveillance and care of the patients in the cohort.

The exemplary embodiments may also enable specifying in declarative form the criteria used to query a memory or a database to generate a list of patients in the cohort. In addition, the exemplary embodiments may provide a user interface(s) that enables specifying of patient data views and layouts for those views as well as defining rules for generation of alerts. One or more of these alerts may be sent to a clinician(s) based on a defined rule(s).

The example embodiments may also enable identification and risk stratification of a patient cohort of interest and may provide ongoing monitoring or surveillance of this cohort (e.g., including alerts) as well as longitudinal patient chart review and analytics on the patient cohort. The exemplary embodiments may also enable provision of additional workflows around patient interaction or care for patients in the patient cohort.

In one exemplary embodiment, a method for identifying patients of a cohort is provided. The method may include generating at least one user interface defining items of predefined criteria to identify a plurality of patients, among a candidate set of patients, of a cohort. The patients may have at least one common characteristic associated with a designated medical condition or a designated health plan. The method may further include identifying the plurality of patients of the cohort in response to receiving indications of selections of one or more of the items of the predefined criteria. The method may further include monitoring and managing care of the identified patients of the cohort on an ongoing basis to provide interventions and track outcomes.

In another example embodiment, an apparatus for identifying patients of a cohort is provided. The apparatus may include a processor and a memory including computer program code. The memory and computer program code are configured to, with the processor, cause the apparatus to at least perform operations including generating at least one user interface defining items of predefined criteria to identify a plurality of patients, among a candidate set of patients, of a cohort. The patients may have at least one common characteristic associated with a designated medical condition or a designated health plan. The memory and computer program code are also configured to, with the processor, cause the apparatus to identify the plurality of patients of the cohort in response to receiving indications of selections of one or more of the items of the predefined criteria. The memory and computer program code are also configured to, with the processor, cause the apparatus to monitor and manage care of the identified patients of the cohort on an ongoing basis to provide interventions and track outcomes.

In another example embodiment, a computer program product for identifying patients of a cohort is provided. The computer program product includes at least one computer-readable storage medium having computer-executable program code instructions stored therein. The computer-executable program code instructions may include program code instructions configured to generate at least one user interface defining items of predefined criteria to identify a plurality of patients, among a candidate set of patients, of a cohort. The patients may have at least one common characteristic associated with a designated medical condition or a designated health plan. The computer program product may further include program code instructions configured to identify the plurality of patients of the cohort in response to receiving indications of selections of one or more of the items of the predefined criteria. The computer program product may further include program code instructions configured to monitor and manage care of the identified patients of the cohort on an ongoing basis to provide interventions and track outcomes.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a communication device according to an exemplary embodiment of the invention;

FIG. 3 is a flowchart of an exemplary method according to an exemplary embodiment of the invention;

FIGS. 4-13 are diagrams illustrating user interfaces for managing patients of a cohort according to exemplary embodiments of the invention; and

FIG. 14 is a flowchart of an exemplary method according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a cohort, cohort of patients, patients of a cohort and similar terms may denote a group of patients, list of patients or population of patients that may have one or more common characteristics that may link the patients together such that care for the patients may be collectively managed.

### General System Architecture

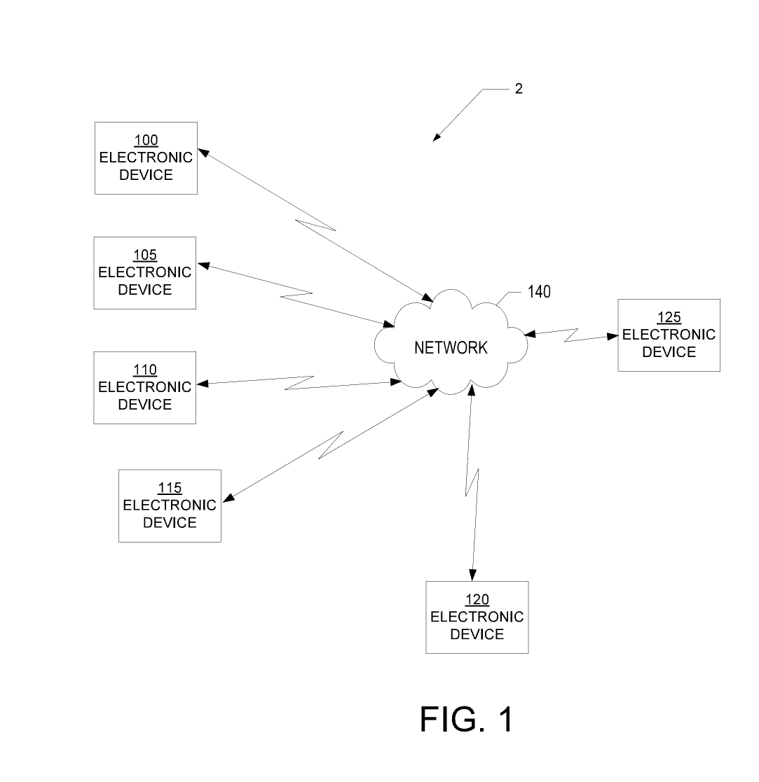

Reference is now made to FIG. 1, which is a block diagram of a system according to exemplary embodiments. As shown in FIG. 1, the system 2 (e.g., a health care system) may include one or more electronic devices 100, 105, 110, 115, 120 and 125 (e.g., personal computers, laptops, workstations, servers, personal digital assistants, smart devices and the like, etc.) which may communicate with each other, over a network 140, such as a wired local area network (LAN) or a wireless local area network (WLAN), a metropolitan network (MAN) and/or a wide area network (WAN) (e.g., the Internet).

In one exemplary embodiment, the electronic devices 100, 105, 110, 115, 120 and 125 may be utilized by clinicians (e.g., nurses, pharmacists, physicians, physical therapists) and/or any other suitable health care professionals. The electronic devices 100, 105, 110, 115, 120, 125 may be maintained by a health care institution or a medical entity.

The electronic devices 100, 105, 110, 115, 120, and 125 may receive medical information from and may transmit medical information to each other. The electronic devices 100, 105, 110, 115, 120 and 125 may utilize the medical information in part to generate one or more health care tasks for one or more patients.

It should be pointed out that although FIG. 1 shows six electronic devices 100, 105, 110, 115, 120 and 125 any suitable number of electronic devices 100, 105, 110, 115, 120 and 125 may be part of the system of FIG. 1 without departing from the spirit and scope of the invention.

### Communication Device

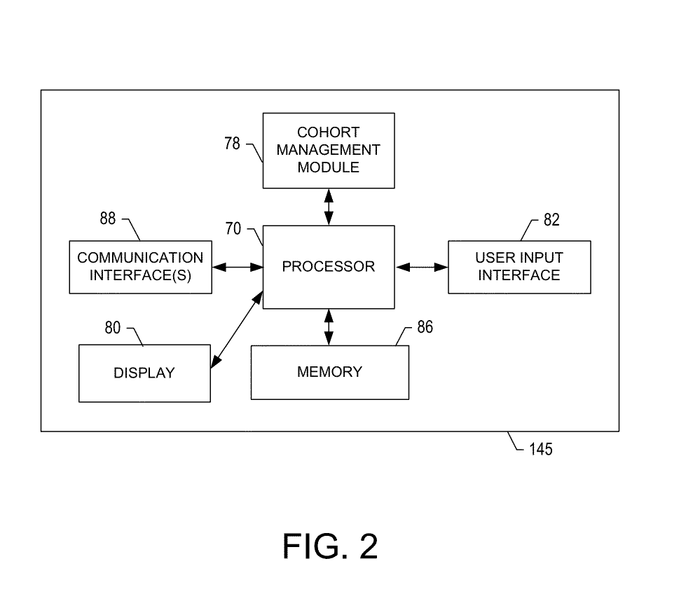

FIG. 2 illustrates a block diagram of a communication device according to an exemplary embodiment of the invention. The communication device 145 is capable of operating as any of electronic devices 100, 105, 110, 115, 120 and 125. In this regard, the electronic devices 100, 105, 110, 115, 120 and 125 may comprise the elements of the communication device 145. The communication device 145 includes various means for performing one or more functions in accordance with exemplary embodiments of the invention, including those more particularly shown and described herein. It should be understood, however, that the communication device 145 may include alternative means for performing one or more like functions, without departing from the spirit and scope of the invention. More particularly, for example, as shown in FIG. 2, the communication device 145 may include a processor 70 connected to a memory 86. The memory 86 may comprise volatile and/or non-volatile memory, and typically stores content (e.g., media content, medical information, etc.), data, information or the like.

For example, the memory 86 may store content transmitted from, and/or received by, other communication devices (e.g., electronic devices 100, 105, 110, 115, 120 and 125). In this regard, in one exemplary embodiment, the memory 86 may store data received from various disparate sources. For example, the memory 86 may store medical information received by the communication device 145 from electronic devices of a hospital, a pharmacy, a laboratory, a clinic, or any other suitable medical entities.

Also for example, the memory 86 may store client applications, instructions, algorithms or the like for execution by the processor 70 to perform steps associated with operation of the communication device 145 in accordance with embodiments of the invention. As explained below, for example, the memory 86 may store one or more client applications such as, for example, software (e.g., software code also referred to herein as computer code).

The processor 70 may be embodied in a variety of ways. For instance, the processor 70 may be embodied as a controller, coprocessor, microprocessor of other processing devices including integrated circuits such as, for example, an application specific integrated circuit (ASIC), a field programmable gate array (FPGA). In an exemplary embodiment, the processor 70 may execute instructions stored in the memory 86 or otherwise accessible to the processor 70.

The communication device 145 may include one or more logic elements for performing various functions of one or more client applications. In an exemplary embodiment, the communication device 145 may execute the client applications. The logic elements performing the functions of one or more client applications may be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the communication device is capable of communicating with other communication devices (e.g., for example, electronic devices 100, 105, 110, 115, 120, 125) over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface may support a wired connection with the respective network.

In addition to the communication interface(s), the interface(s) may also include at least one user interface that may include one or more earphones and/or speakers, a display 80 (also referred to herein as screen 80), and/or a user input interface 82. The user input interface, in turn, may comprise any of a number of devices allowing the entity to receive data from a user, such as a microphone, a keypad, keyboard, a touch display, a joystick, image capture device, pointing device (e.g., mouse), stylus or other input device.

In an exemplary embodiment, the processor 70 may be in communication with and may otherwise control a cohort management module 78. The cohort management module 78 may be any means such as a device or circuitry operating in accordance with software or otherwise embodied in hardware or a combination of hardware and software thereby configuring the device or circuitry (e.g., a processor, controller, microprocessor or the like) to perform the corresponding functions of the cohort management module 78, as described below. In examples in which software is employed, a device or circuitry (e.g., processor 70 in one example) executing the software forms the structure associated with such means. As such, for example, the cohort management module 78 may be configured to, among other things, define criteria for identifying patients of a cohort and configuring views of patient information for patients in the cohort, as described more fully below.

### Exemplary System Operation

Exemplary embodiments of the invention may provide an efficient and reliable mechanism for defining criteria for identification of a patient cohort of interest and enabling provision of one or more configurable user interfaces which provide patient information for the patients in the cohort. The exemplary embodiments may also monitor and manage care of the patients in the cohort, as well as perform other features described more fully below.

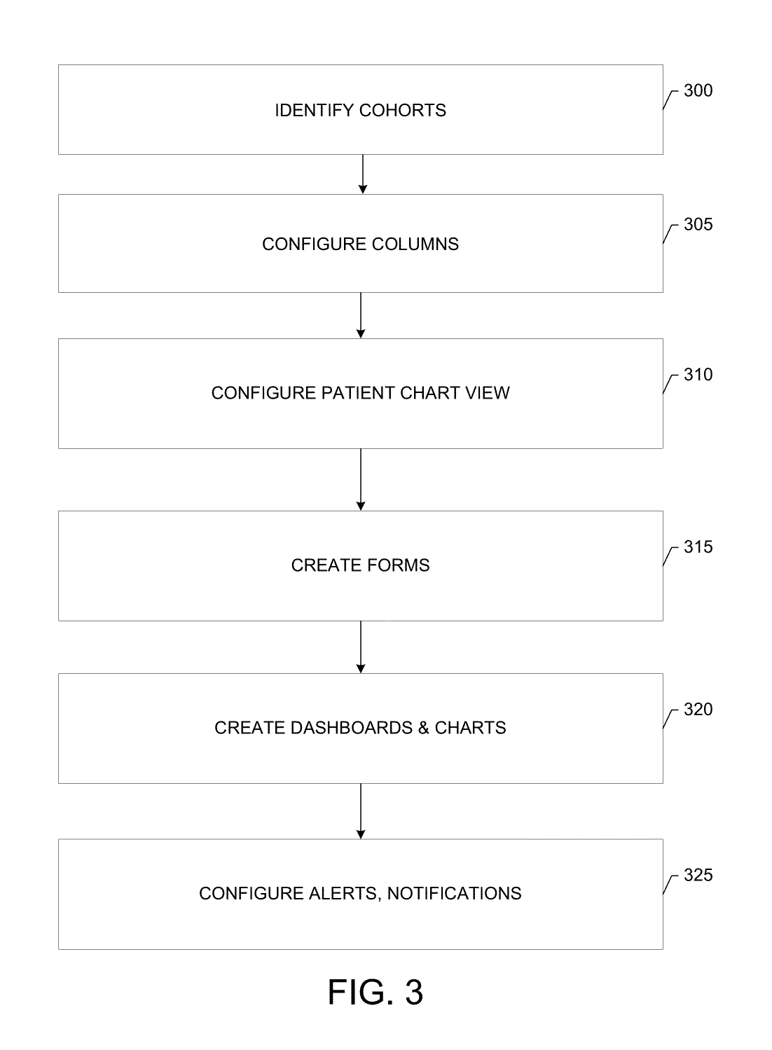

Referring now to FIG. 3, a flowchart of an exemplary method for patient cohort management is provided according to an exemplary embodiment. The cohort management module 78 may enable a user such as, for example, a clinician (e.g., a health care knowledge worker, nurse, physician, laboratory technician, etc.) to perform one or more steps to define a new cohort management solution.

At operation 300, the cohort management module 78 may provide a set of criteria for a user to identify patients that should be included in the cohort (e.g., a group of patients for a heart program, a diabetes program, a smoking cessation campaign or any other suitable group of patients). The cohort management module 78 may provide the set of criteria for selection by the user (e.g., a clinician) to a user interface. At operation 305, the cohort management module 78 may provide (e.g., via a user interface) one or more options for the user configuring columns. In this regard, the user may select one or more columns of medical data that the user desires the cohort management module 78 to retrieve to be shown in corresponding columns of a user interface by a display (e.g., display 80). At operation 310, the cohort management module 78 may enable configuration of one or more patient chart views. In this regard, the cohort management module 78 may provide visible indicia, for example via a user interface, for the user to select one or more patient chart views for the patients of the cohort.

At operation 315, the cohort management module 78 may provide a user with options, via a user interface, to select one or more forms to be filled in for the patients of the cohort, or provide the user with the option to author one or more new forms. At operation 320, the cohort management module 78 provides the user with the ability to create one or more dashboards or user interfaces and/or charts based in part on the configured columns, the configured patient chart view(s) and/or the created forms. In this regard, the cohort management module 78 may trigger a display (e.g., display 80) to show the dashboards or user interfaces and charts. At operation 325, the cohort management module 78 may provide visible indicia, for example via a user interface, for configuring one or more alerts or notifications. In this regard, the user may select or define one or more alerts or notifications to be generated and sent in response to criteria being met (e.g., in an instance in which patients of the cohort are entered into an intensive care unit (ICU), an emergency room, etc.). The alert(s) or notification(s) (e.g., an email message, a Short Message Service (SMS) message, a Multimedia Messaging Service (MMS) message or any other suitable message) may be sent to one or more devices (e.g., electronic devices 100, 105, 110, 115, 120 or 125) of the user (e.g., a nurse) configuring the alert(s)/notification(s) or other users (e.g., physicians) designated by the user.

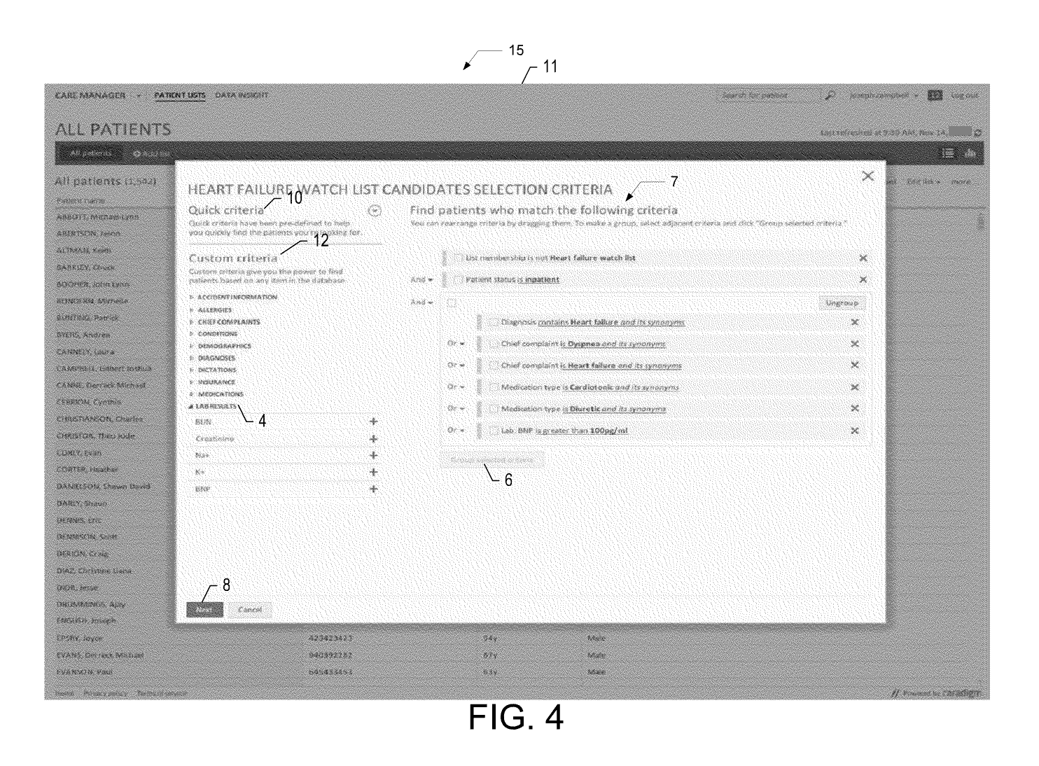

Referring now to FIG. 4, a diagram of a user interface for defining or identifying patients of a cohort is provided according to according to an exemplary embodiment of the invention. For purposes of illustration and not of limitation, in the example embodiment of FIG. 4, the criteria for the patients of the cohort may relate to candidate patients (e.g., 1542 candidate patients) for heart failure. However, in other example embodiments the identity of the patients for the cohort may relate to candidate patients for other medical conditions (e.g., diabetes, etc.) or health care plans (e.g., a smoking cessation campaign, a teen pregnancy prevention program, etc.).

In the example embodiment of FIG. 4, the user interface 11 may be shown via a display 15 (e.g., display 80) generated by the cohort management module 78. The user interface 11 includes visible indicia denoting criteria 12 that a user (e.g., clinician) may select for identifying candidate patients of the hearth failure cohort. The criteria 12 may include accident information, allergies information, chief complaints of patients, conditions (e.g., medical conditions), demographics, diagnoses, dictations, insurance, medications and lab results. In the example embodiment of FIG. 4, the user interface 11 presents for selection (e.g., via a user input interface (e.g., user input interface 82)) from a user of lab results 4 (blood urea nitrogen (BUN), creatinine, sodium (NA+), potassium (K+), brain natriuretic peptide, (BNP)) from the criteria 12 and specifies particular results to be searched for identifying patients for inclusion in the cohort of patients for heart failure.

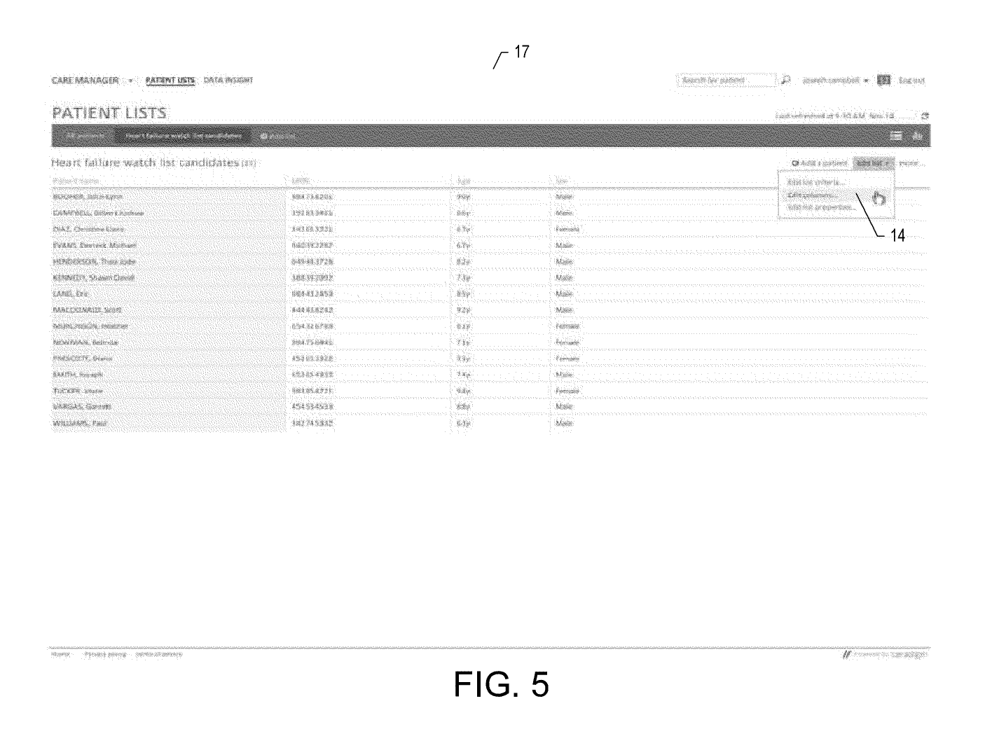

The user interface 11 may also provide visible indicia for finding patients who match criteria 7. The finding patients who match criteria 7 may include options for selections such as, for example, list membership is not heart failure watch list, patient status in inpatient, diagnosis contains heart failure and its synonyms, chief complaint is dyspnea and its synonyms, chief complaint is heart failure and its synonyms, medication type is diuretic and its synonyms, BNP is greater than 100 pg/ml, as well as any other suitable criteria. The user interface 11 may also include visible indicia denoting quick criteria 10 which may be predefined to help users quickly put together their query criteria to find/identify patients for the cohort related to heart failure. In response to receipt of an indication of the group selected criteria tab 6 and the next tab 8, the cohort management module 78 may generate another user interface (e.g., user interface 17 of FIG. 5) identifying patients of the cohort.

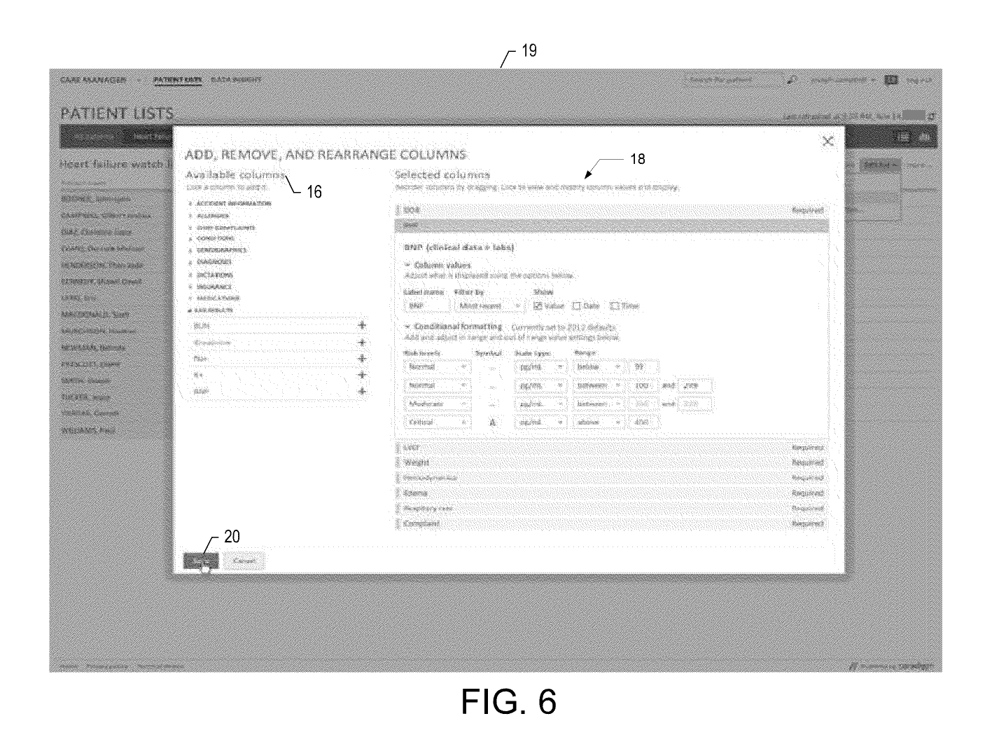

Referring now to FIG. 5, a user interface illustrating identified patients of a cohort is provided according to an example embodiment. In the example embodiment of FIG. 5, the user interface 17 denoting the identified patients of the cohort may be shown in response to selecting the group selected tab 6 and the next tab 8 of the user interface 11. In the example embodiment of FIG. 4, the cohort management module 78 identified fifteen patients of the cohort for heart failure which may be shown via visible indicia in the user interface 17. In response to receipt of an indication of an edit column menu item 14, from an edit list, the cohort management module 78 may generate a user interface (e.g., user interface 19 of FIG. 6) with one or more configurable options to add, remove or rearrange columns.

Referring now to FIG. 6, a user interface for editing one or more columns is provided according to an exemplary embodiment. The cohort management module 78 may generate the user interface 19 in response to receipt of an indication of a selection of the edit column menu item 14 of the user interface 17. The user interface 19 may include visible indicia denoting available columns 16 for selection and visible indicia indicating selected columns 18. In the example embodiment of FIG. 6, the cohort management module 78 received an indication of a selection (for example by a user via a user input interface) of columns such as, for example, date of birth (DOB), BNP, left ventricular ejection fraction (LVEF), weight, hemodynamics, edema, respiratory rate and complaint. In this regard, the selected columns may be included in a user customizable/configurable user interface display, generated by the cohort management module 78, denoting visible indicia indicating to the selected columns for medical data of patients of the cohort for heart failure. The cohort management module 78 may generate the customizable/configurable dashboard or user interface in response to receipt of a selection of the save tab 20.

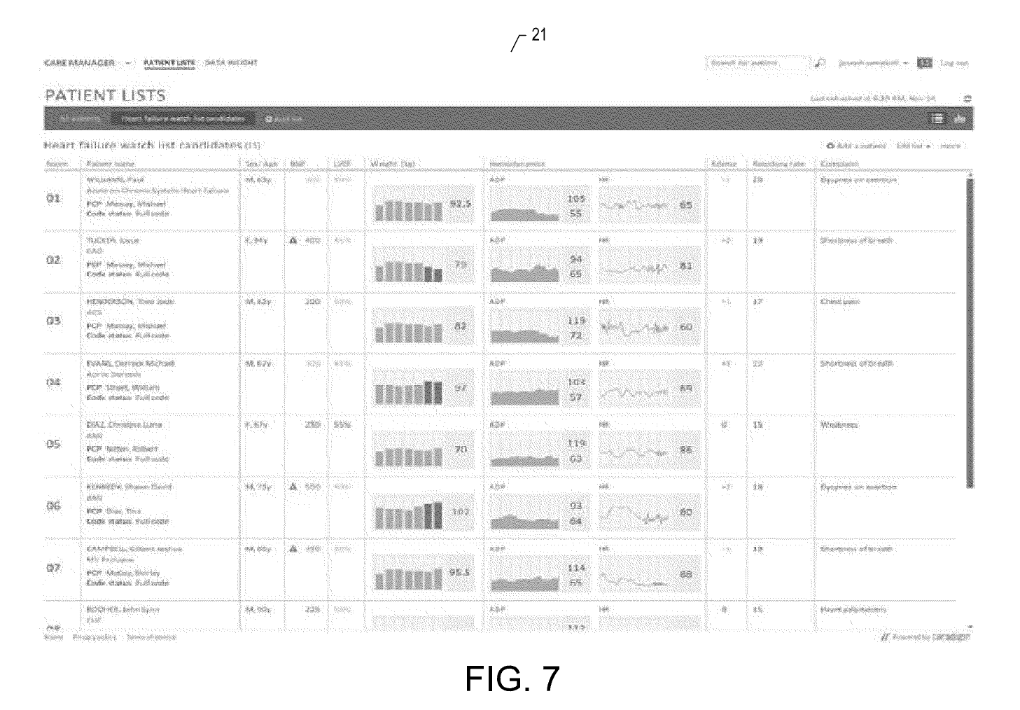

Referring now to FIG. 7, a diagram illustrating a user interface indicating one or more selected columns for inclusion in the user interface is provided according to an example embodiment. In the example embodiment of FIG. 7, the cohort management module 78 generated the user interface 21 (also referred to herein as dashboard 21) which includes visible indicia of medical data for the selected columns 18 (e.g., BNP, LVEF, weight, hemodynamics, edema, respiratory rate, complaint) of the user interface 19 corresponding to the patients of the cohort (e.g., the fifteen patients of the cohort) for heart failure in response to receipt of selection of the save tab 20.

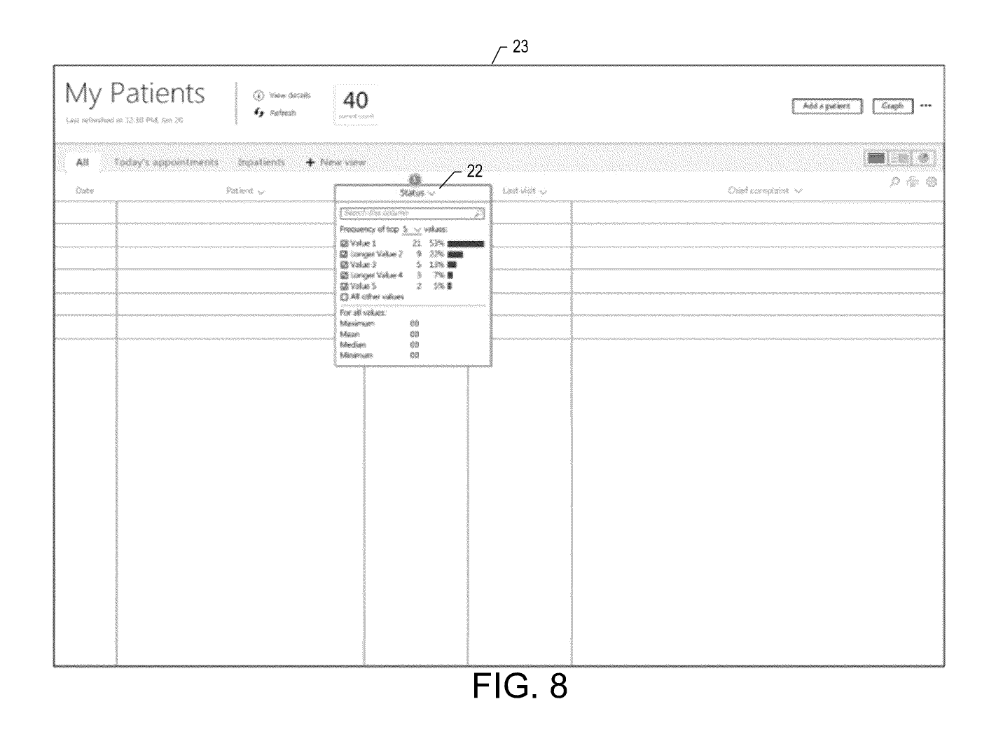

Referring now to FIG. 8, a diagram illustrating a user interface indicating status information is provided according to an example embodiment of the invention. The cohort management module 78 may generate the user interface 23. In the example embodiment of FIG. 8, the user interface 23 may provide visible indicia denoting additional insight or analytics on the status of medical data for a selected column (e.g., hemodynamics) for patients of the cohort. In this manner, in response to receipt of a selection of the status tab 22, the cohort management module 78 enable the user interface 23 to include visible indicate denoting statistics for one or more of the patients of the cohort for a selected column in a concise manner.

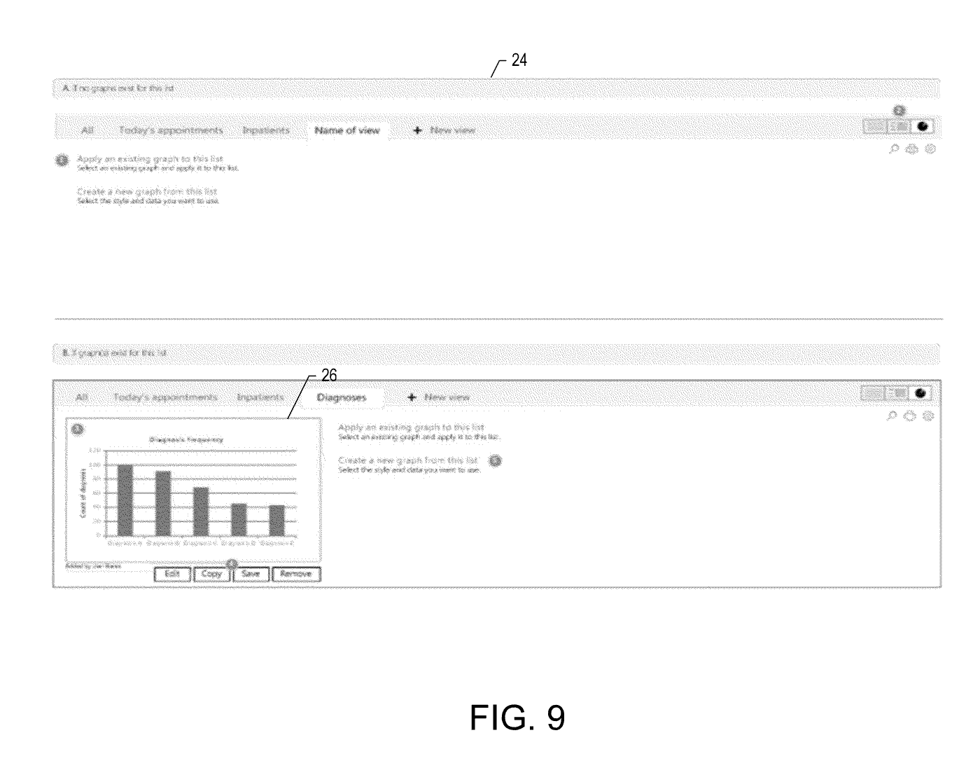

Referring now to FIG. 9, a diagram illustrating a user interface indicating graphical data is provided according to an example embodiment. The cohort generation module 78 may generate the user interface 24. In the example embodiment of FIG. 9, the cohort management module 78 may provide visible indicia in the user interface 24 indicating one or more graphs 26 of medical data of patients of the cohort for a selected set of indicators (e.g., diagnoses (e.g., congestive heart failures, mild cardiac infractions, etc.)) pertaining to heart failure.

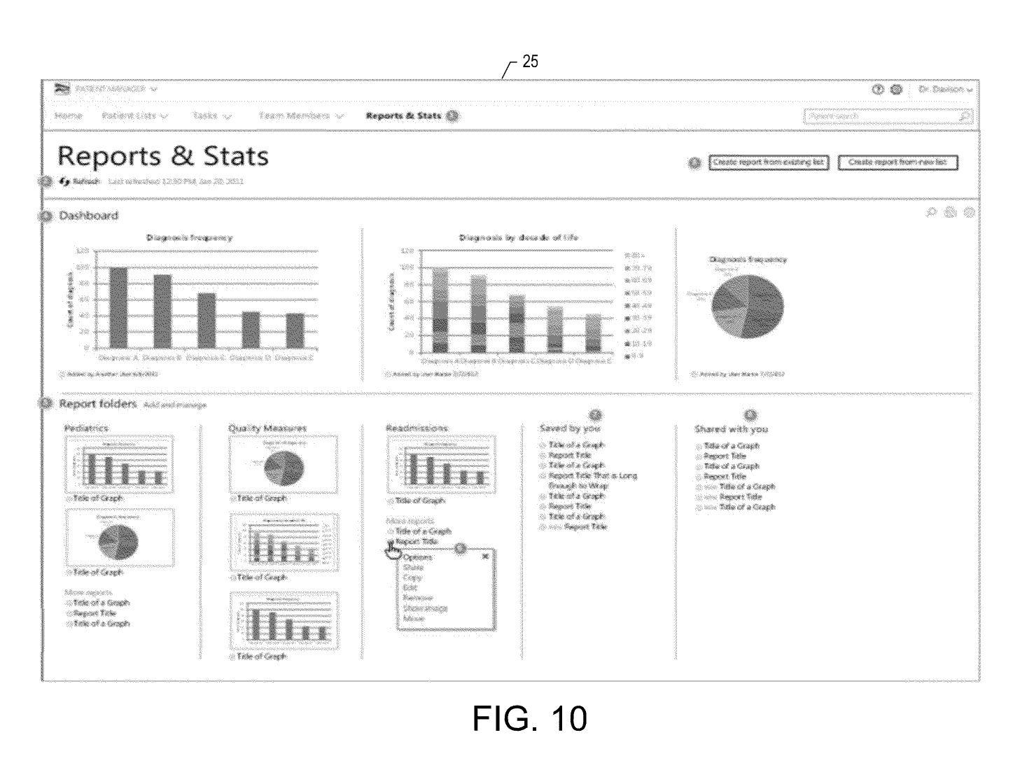

Referring now to FIG. 10, a diagram illustrating a user interface including reports and statistics is provided according to an exemplary embodiment of the invention. In the example embodiment of FIG. 10, the cohort management module 78 may generate the user interface 25 (also referred to herein as dashboard 25). The user interface 25 may be a dashboard of various reports and statistical data corresponding to status information for one or more selected columns for patients of a cohort pertaining to heart failure, for example. In this regard, the visible indicia of the user interface 25 may indicate data in graphical form and statistical status data for the one or more selected columns for patients of the cohort.

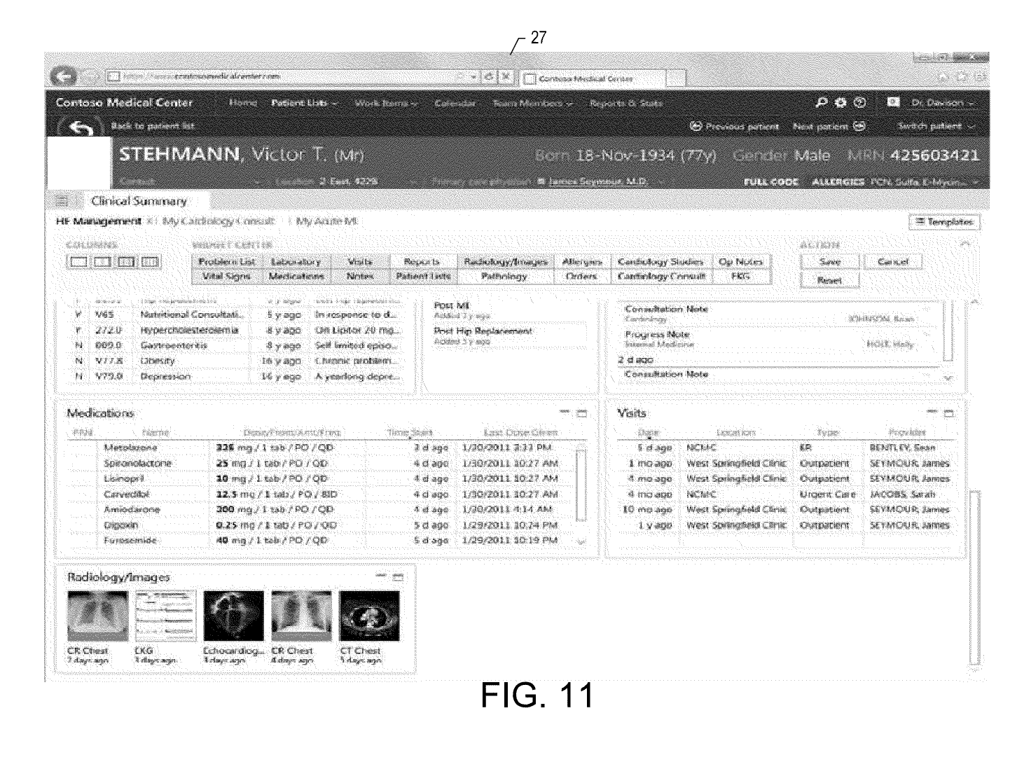

Referring now to FIG. 11, a diagram illustrating a user interface including medical data for a single patient of a cohort is provided according to an exemplary embodiment of the invention. In an example embodiment, the cohort management module 78 may pre-configure a single patient view user interface 27 (also referred to herein as user interface 27), in response to receiving indications (e.g., selections of a user input via a user input interface (e.g., user input interface 82)) of the data to include in the single patient view user interface 27 for interacting with a single patient such as, for example, Victor T. Stehmann a fictitious person. In the example embodiment of FIG. 11, the indicated data for inclusion in the single patient view user interface 27 may include, but is not limited to, desired widgets of a widget center, medications, visits, radiology images, and any other suitable indicated data. In an example embodiment, the cohort management module 78 may provide the visible indicia of the user interface 27 to a display (e.g., display 80) in response to receipt of a selection (e.g., selection of an identified patient in the user interface 21) of a patient of a cohort.

In some other example embodiments, a single patient view user interface may include a combination of multiple full page dashboards and/or composite user interfaces. In this regard, the cohort management module 78 may configure (in response to receipt of selections from a user) which dashboards and/or composite user interfaces are relevant for a given cohort and the manner (e.g., the order) in which they may be displayed via the single patient view user interface.

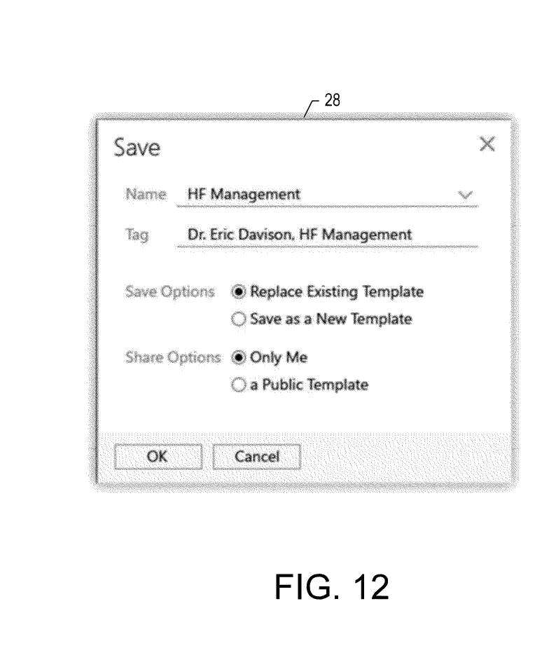

Referring now to FIG. 12, a diagram illustrating a user interface for saving a single patient view user interface is provided according to an example embodiment. In this regard, the cohort management module 78 may save a single patient view user interface (e.g., user interface 27) as a template for reuse across one or more cohorts. In this manner, the cohort management module 78 may generate a user interface 28 that provides one or more options for saving an existing template for a single patient view user interface as a new template or replacing the existing template. The user interface 28 may also include data that allows a user (e.g., a clinician) to choose the selections for creation of a single patient view user interface (e.g., user interface 27) to utilize the template for the single patient view user interface for other patients assigned to the user. Additionally, the user interface 28 may include data enabling a user to share the template of a generated single patient view user interface with other users (e.g., other clinicians). In this manner, the other users may utilize the template for configuring single patient views of other patients.

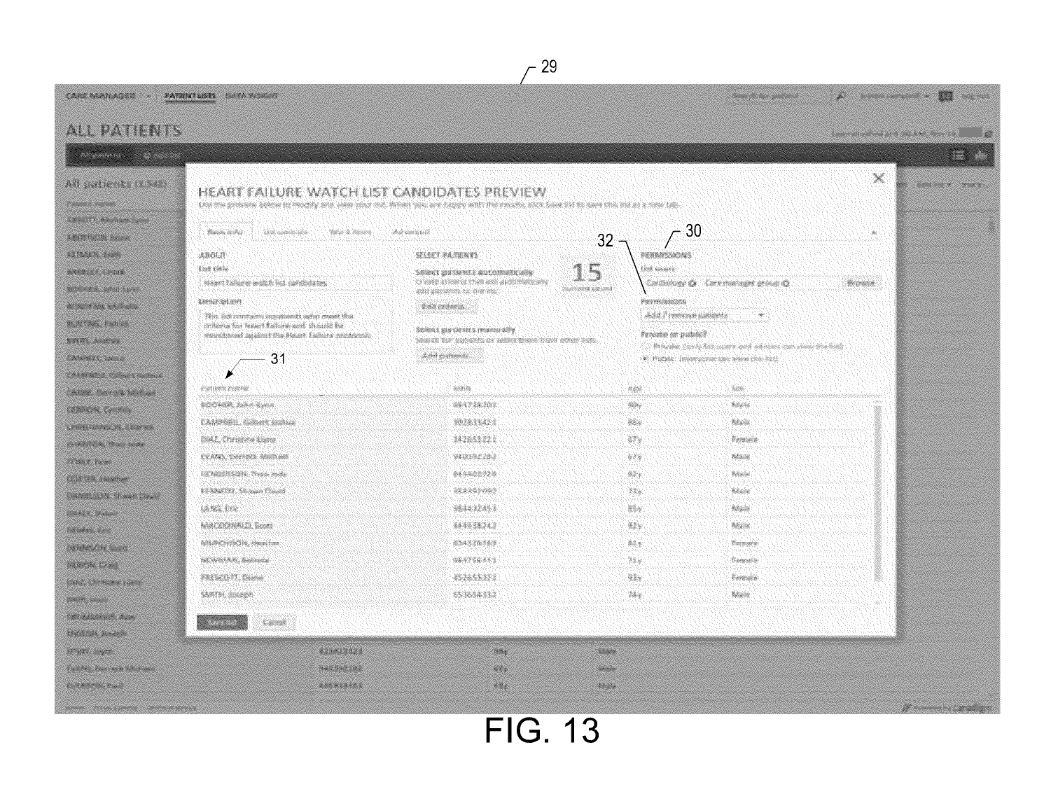

Referring now to FIG. 13, a diagram illustrating a user interface according to an example embodiment is provided. In the example embodiment of FIG. 13, in response to finalizing the user interface 29 and determining that the user interface 29 is ready for use, the cohort management module 78 may enable the user interface 29 to be uploaded (e.g., to a production environment) or published for use across multiple sites/services. The user interface 29 may include visible indicia denoting permissions 30, generated by the cohort management module 78, enabling a user to choose to share the user interface 29 including the list of patients 31 (also referred to herein as list 31) of a cohort that meets criteria for heart failure with other users (e.g., other care managers in a cardiology department).

The user interface 29 may also include visible indicia denoting permissions 32, generated by the cohort management module 78, enabling a user (e.g., a clinician) to add and/or remove patients from the list 31. By providing the user interface 29 with the list of patients 31 to other care managers the other care managers may have the ability to add and/or remove patients from the list of patients of the cohort that meet criteria for heart failure.

In some example embodiments, the cohort management module 78 may enable configuring of forms for data entry for the list of patients 31 of the cohort. For example, forms to capture medical history of patients and/or for performing an initial assessment. The cohort management module 78 may also enable configuring one or more workflows. In addition, the cohort management module 78 may also enable configuring and defining of alerts or notifications that may be generated based in part on defined events, defined rules or the like. For purposes of illustration and not of limitation, a rule(s) may be predefined (e.g., by a user) and stored in a memory (e.g., memory 86) to send an alert/notification to a device of a primary care provider (PCP) (e.g., a physician) in response to detecting an acute care/emergency admission event associated with one or more patients of a cohort. As such, the cohort management module 78 may send an alert/notification (e.g., email message, SMS message, MMS message, etc.) to a device (e.g., electronic device 105) of a patient's primary care provider in response to detecting an acute care or emergency admission event associated with the patient of the cohort.

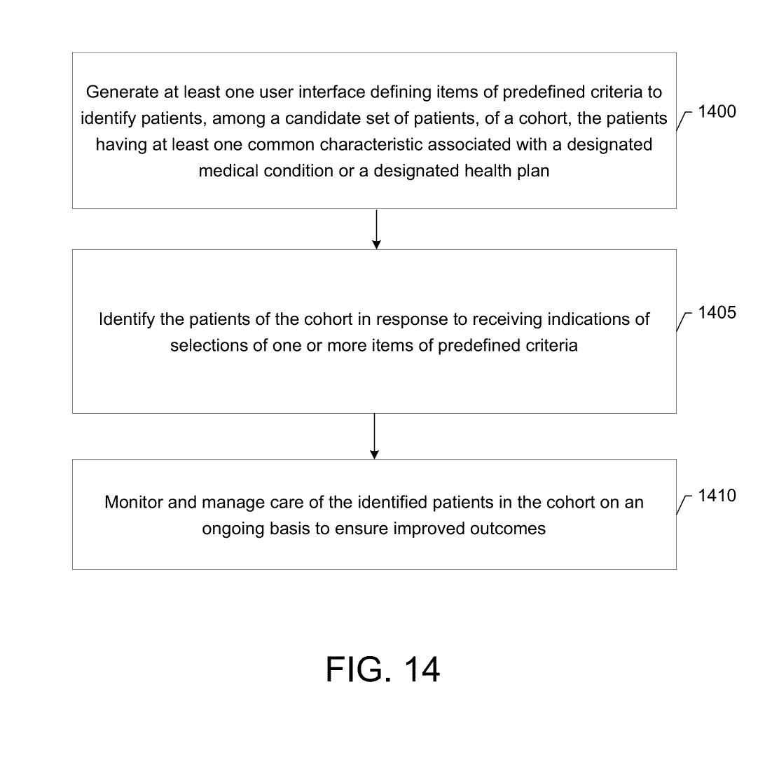

Referring now to FIG. 14, an exemplary method for identifying patients of a cohort is provided according to an exemplary embodiment. At operation 1400, an apparatus (e.g., communication device 145) may generate at least one user interface (e.g., user interface 11) defining items of predefined criteria to identify a plurality of patients, among a candidate set of patients, of a cohort. The patients may have at least one common characteristic (e.g., heart failure symptoms) associated with a designated medical condition (e.g., heart failure, diabetes, etc.) or a designated health plan (e.g., a smoking cessation campaign, a teen pregnancy prevention plan, etc.).

At operation 1405, the apparatus (e.g., communication device 145) may identify the plurality of patients (e.g., list of patients 31) of the cohort in response to receiving indications of selections of one or more of the items of the predefined criteria (e.g., quick criteria 10, custom criteria 12, etc.). At operation 1410, the apparatus (e.g., communication device 145) may monitor and manage care of the identified patients of the cohort on an ongoing basis to provide the necessary interventions and track outcomes to improvement. In some other example embodiments, the apparatus (e.g., communication device 145) may monitor and manage care of the identified patients of the cohort to facilitate determining whether one or more of the identified patients have a medical condition (e.g., heart failure, diabetes) or are candidates for a health plan (e.g., a smoking cessation program, a teen prevention program, etc.).

It should be pointed out that FIGS. 3 and 14 are flowcharts of a system, method and computer program product according to exemplary embodiments of the invention. It will be understood that each block or step of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86) and executed by a processor (e.g., processor 70, cohort management module 78). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowcharts blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts blocks or steps.

Accordingly, blocks or steps of the flowcharts support combinations of means for performing the specified functions and combinations of steps for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In an exemplary embodiment, an apparatus for performing the methods of FIGS. 3 and 14 above may comprise a processor (e.g., the processor 70, the cohort management module 78) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70 (e.g., as means for performing any of the operations described above), the cohort management module 78 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
generating at least one user interface defining items of predefined criteria to identify a plurality of patients, among a candidate set of patients, of a cohort, the patients having at least one common characteristic associated with a designated medical condition or a designated health plan;
identifying, via a processor, the plurality of patients of the cohort in response to receiving indications of selections of one or more of the items of the predefined criteria; and
monitoring and managing care of the identified patients of the cohort on an ongoing basis to provide interventions and track outcomes.

2. The method of claim 1, further comprising:
generating visible indicia of another user interface enabling configuring of one or more views of patient information for the identified patients in the cohort.

3. The method of claim 1, further comprising:
configuring medical information of another user interface to display for the identified patients of the cohort in response to receiving indications of selected health care data.

4. The method of claim 3, wherein receiving indications of selected data comprises selecting one or more items of data for inclusion in corresponding columns of the user interface, at least a subset of the selected data corresponds to medical data of the identified patients that is utilized in part in the determining of whether one or more of the patients have the medical condition.

5. The method of claim 4, further comprising:
generating visible indicia denoting at least one of statistical data or graphical data corresponding to data of the columns for one or more of the identified patients.

6. The method of claim 1, further comprising:
generating a single patient user interface, on behalf of a patient, among the identified patients, in response to receipt of an indication of a selection of the patient of the cohort, the single patient user interface comprising visible indicia denoting health care data, of the patient, and one or more forms utilized to manage care of the patient, pre-designated by a user for inclusion in the single patient user interface.

7. The method of claim 6, further comprising:
enabling saving of the single patient user interface as a template for reuse among one or more other designated cohorts including other patients.

8. The method of claim 1, further comprising:
enabling provision of the user interface denoting the identified patients of the cohort to one or more users in response to receipt of an indication specifying that the users are permitted to utilize the user interface.

9. The method of claim 8, further comprising:
enabling the users to add at least one new patient to the identified patients or remove at least one of the patients from the identified patients in response to receipt of an indication denoting that the users are permitted to alter the identified patients of the cohort.

10. An apparatus comprising at least one processor and at least one memory including computer program code, the at least one memory and the computer program code configured to, with the processor, cause the apparatus to at least:
generate at least one user interface defining items of predefined criteria to identify a plurality of patients, among a candidate set of patients, of a cohort, the patients having at least one common characteristic associated with a designated medical condition or a designated health plan;
identify the plurality of patients of the cohort in response to receiving indications of selections of one or more of the items of the predefined criteria; and
monitor and manage care of the identified patients of the cohort on an ongoing basis to provide interventions and track outcomes.

11. The apparatus of claim 10, wherein the memory and computer program code are further configured to, with the processor, cause the apparatus to:
generate visible indicia of another user interface enabling configuring of one or more views of patient information for the identified patients in the cohort.

12. The apparatus of claim 10, wherein the memory and computer program code are further configured to, with the processor, cause the apparatus to:
configure medical information of another user interface to display for the identified patients of the cohort in response to receiving indications of selected health care data.

13. The apparatus of claim 12, wherein the memory and computer program code are further configured to, with the processor, cause the apparatus to:
facilitate the receiving of the indications of selected health data by selecting one or more items of data for inclusion in corresponding columns of the another user interface, at least a subset of the selected data corresponds to medical data of the identified patients that is utilized in part in the determining of whether one or more of the patients have the medical condition.

14. The apparatus of claim 13, wherein the memory and computer program code are further configured to, with the processor, cause the apparatus to:
generate visible indicia denoting at least one of statistical data or graphical data corresponding to data of the columns for one or more of the identified patients.

15. The apparatus of claim 10, wherein the memory and computer program code are further configured to, with the processor, cause the apparatus to:
generate a single patient user interface, on behalf of a patient, among the identified patients, in response to receipt of an indication of a selection of the patient of the cohort, the single patient user interface comprising visible indicia denoting health care data, of the patient, and one or more forms to manage care of the patient, pre-designated by a user for inclusion in the single patient user interface.

16. The apparatus of claim 15, wherein the memory and computer program code are further configured to, with the processor, cause the apparatus to:
enable saving of the single patient user interface as a template for reuse among one or more other designated cohorts including other patients.

17. The apparatus of claim 10, wherein the memory and computer program code are further configured to, with the processor, cause the apparatus to:
enable provision of the user interface denoting the identified patients of the cohort to one or more users in response to receipt of an indication specifying that the users are permitted to utilize the user interface.

18. The apparatus of claim 17, wherein the memory and computer program code are further configured to, with the processor, cause the apparatus to:
enable the users to add at least one new patient to the identified patients or remove at least one of the patients from the identified patients in response to receipt of an indication denoting that the users are permitted to alter the identified patients of the cohort.

19. A computer program product comprising at least one non-transitory computer-readable storage medium having computer-executable program code instructions stored therein, the computer executable program code instructions comprising:
program code instructions configured to generate at least one user interface defining items of predefined criteria to identify a plurality of patients, among a candidate set of patients, of a cohort, the patients having at least one common characteristic associated with a designated medical condition or a designated health plan;
program code instructions configured to identify the plurality of patients of the cohort in response to receiving indications of selections of one or more of the items of the predefined criteria; and
program code instructions configured to monitor and manage care of the identified patients of the cohort on an ongoing basis to provide interventions and track outcomes.

20. The computer program product of claim 19, further comprising:
program code instructions configured to generate visible indicia of another user interface enabling configuring of one or more views of patient information for the identified patients in the cohort.
